(19) United States
(12) Patent Application Publication
(10) Pub. No.: US 2024/0407598 A1
(43) Pub. Date: Dec. 12, 2024

(54) CASING OF OVEN

(71) Applicant: GRAND MATE CO., LTD., Taichung City (TW)

(72) Inventors: CHIN-YING HUANG, Taichung City (TW); HSIN-MING HUANG, Taichung City (TW); HSING-HSIUNG HUANG, Taichung City (TW); YEN-JEN YEH, Taichung City (TW); CHIEN-CHANG LIN, Taichung City (TW)

(73) Assignee: GRAND MATE CO., LTD., Taichung City (TW)

(21) Appl. No.: 18/207,096

(22) Filed: Jun. 7, 2023

(51) Int. Cl. A47J 37/06

(52) U.S. Cl. CPC A47J 37/0623

(57) ABSTRACT

A casing of an oven includes a base, two first plates and two second plates. The base has two first pivot portions and two second pivot portions. Two first axes and two second axes are defined. Each of the two first axes passes through one of the two first pivot portions. Each of the two second axes passes through one of the two second pivot portions. Each of the two first axes and the two second axes re spaced apart from one another in a height direction of the base. Each of the two first plates is pivotally connected to one of the two first pivot portions. Each of the two second plates is pivotally connected to one of the two second pivot portions. As the four axes are respectively located at different positions in the height direction of the base, the two first plates could be stacked and the two second plates could be stacked upon folding the casing.

### BACKGROUND

### Technical Field

The present disclosure relates generally to a casing of an oven, and more particularly to a casing, which could be disassembled and assembled.

### Description of Related Art

A conventional oven includes a casing and a heater, wherein the casing has a baking space therein adapted to receive a baking object. The heater is disposed in the casing and is adapted to heat the baking space, so that the baking object is heated in the baking space.

For example, it is convenient and interesting for baking food with a domestic oven. However, as the casing of the oven is constituted of a plurality of plates and the plates are fixed to one another, the shape of the casing is fixed and the casing occupies a considerable space, and thus a user is required to carry the casing upon moving the oven, thereby causing inconvenience in moving the oven. Additionally, upon storing the oven, as the casing occupies a considerable space, a larger storage space is required to store the casing of the oven.

Due to the inconvenience in moving and storing the oven, the oven is generally disposed and used at a fixed position in home, and is seldomly brought and used during outdoor camping.

In all aspects, the conventional oven still has room for improvement.

### BRIEF SUMMARY

In view of the above, a primary objective of the present disclosure is to provide a casing of an oven, which could be disassembled and assembled, wherein when the casing is folded, plates could be stacked, thereby reducing the size of the casing. The present disclosure provides a casing of an oven including a base, two first plates, and two second plates. The base has two first side portions and two second side portions, wherein each of the two first side portions has two first pivot portions. Each of the two second side portions has two second pivot portions. Two first axes and two second axes are defined, wherein each of the two first axes passes through the two first pivot portions of one of the two first side portions. Each of the two second axes passes through the two second pivot portions of one of the two second side portions. Each of the two first axes and the two second axes are spaced apart from one another in a height direction of the base. The two first plates respectively have two first pivot ears, wherein each of the two first pivot ears of each of the two first plates is pivotally connected to one of the two first pivot portions of one of the two first side portions. Each of the two first plates is pivotable between a first folded position and a first assembled position relative to the base. When each of the two first plates pivots to the first folded position, the two first plates are stacked in the height direction of the base. The two second plates respectively have two second pivot ears, wherein each of the two second pivot ears of each of the two second plates is pivotally connected to one of the two second pivot portions of one of the two second side portions. Each of the two second plates is pivotable between a second folded position and a second assembled position relative to the base. When each of the two second plates pivots to the second folded position, the two second plates are stacked in the height direction of the base. When each of the two first plates pivots to the first assembled position and each of the two second plates pivots to the second assembled position, the two first plates and the two second plates jointly surround to form a baking space.

With the aforementioned design, as the four axes are respectively located at different positions in the height direction of the base, the two first plate could be stacked and the two second plates could be stacked in the height direction of the base, so that the size of the casing could be effectively reduced, thereby facilitating the storage of the casing.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the oven according to a first embodiment of the disclosure;

FIG. 2 is a perspective view of the oven according to the first embodiment of the disclosure, showing the door being pivoted to the open position;

FIG. 3 is a perspective view of the base according to the first embodiment of the disclosure;

FIG. 4 is a partially exploded view of the oven according to the first embodiment of the disclosure, showing the top cover being separated;

FIG. 5 is a front view of the casing according to the first embodiment of the disclosure;

FIG. 6 is a sectional view along the 6-6 line in FIG. 5, wherein the oven rack is not shown;

FIG. 7 is a partially enlarged view of a marked region A in FIG. 6;

FIG. 8 is a schematic view showing the door being pivoted to the open position;

FIG. 9 is a partially enlarged view of a marked region B in FIG. 6;

FIG. 10 is a partially exploded view of the oven according to the first embodiment of the present invention, showing the casing being in an expanded state;

FIG. 11 is a left side view of the casing according to the first embodiment of the disclosure, showing the casing being in the expanded state;

FIG. 12 is a front view of the casing according to the first embodiment of the disclosure, showing the casing being in the expanded state;

FIG. 13 is a front view of the casing according to the first embodiment of the disclosure, showing the two second plates being folded;

FIG. 14 is a perspective view of the casing according to the first embodiment of the disclosure, showing one of the first plates being folded;

FIG. 15 is a perspective view of the casing according to the first embodiment of the disclosure, showing the oven rack being placed on one of the first plates that is folded;

FIG. 16 is a perspective view of the casing according to the first embodiment of the disclosure, showing the other first plate being folded;

FIG. 17 is a perspective view of the casing according to the first embodiment of the disclosure, showing the casing being in a folded state;

FIG. 18 is a front view of the casing of the oven according to an alternative embodiment of the disclosure, showing the two second plates being folded;

FIG. 19 is a front view of the oven according to a second embodiment of the disclosure;

FIG. 20 is a sectional view along the 20-20 line in FIG. 19;

FIG. 21 is a perspective view of the oven according to a third embodiment of the disclosure;

FIG. 22 is a perspective view of the oven according to a fourth embodiment of the disclosure;

FIG. 23 is a perspective view of the oven according to the fourth embodiment of the disclosure seen from another direction;

FIG. 24 is a partially exploded view of the oven according to the fourth embodiment of the disclosure, showing the top cover being separated;

FIG. 25 is a side view of the oven according to the fourth embodiment of the disclosure;

FIG. 26 is a sectional view along the 26-26 line in FIG. 25;

FIG. 27 is a partially enlarged view of a marked region C in FIG. 25;

FIG. 28 is a schematic top view of the oven according to the fourth embodiment of the disclosure, showing the handle being pivoted between the first position and the second position; and

FIG. 29 is a front view of the oven according to the fourth embodiment of the disclosure, showing the door being opened.

### DETAILED DESCRIPTION

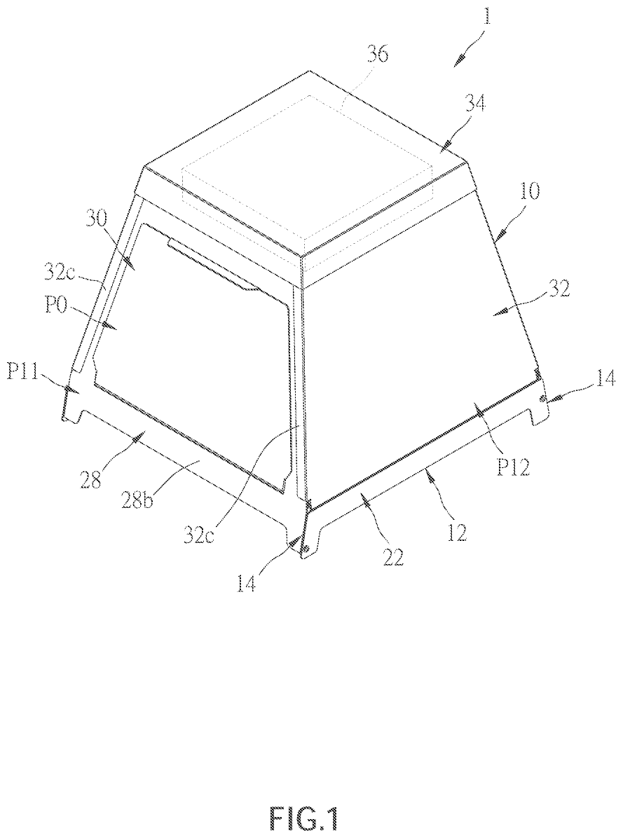

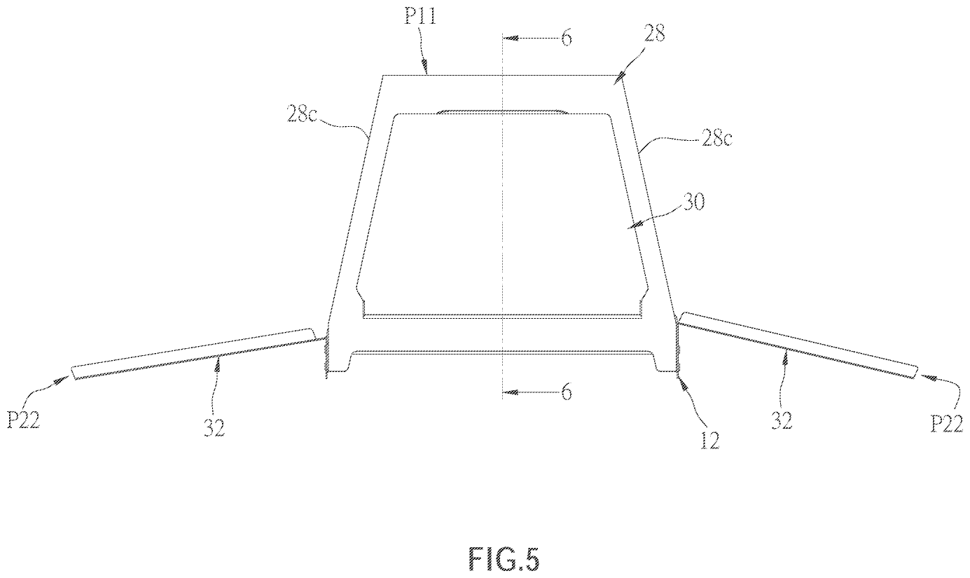

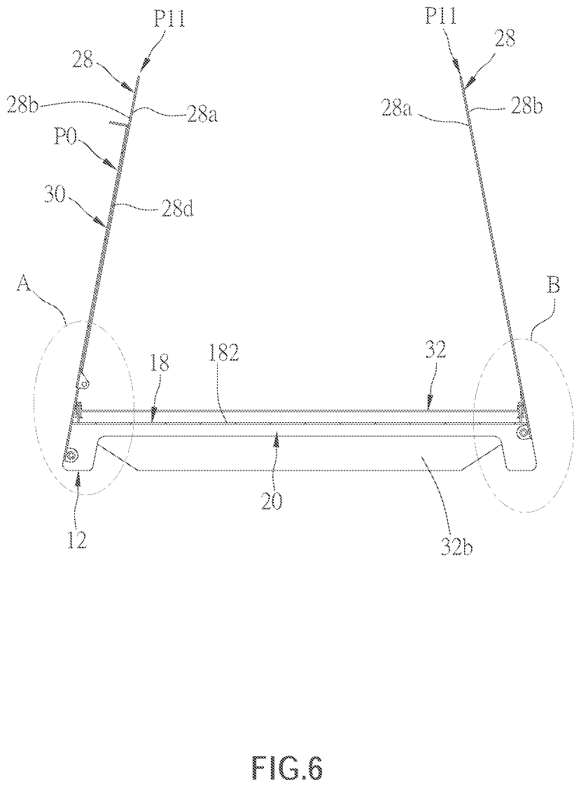

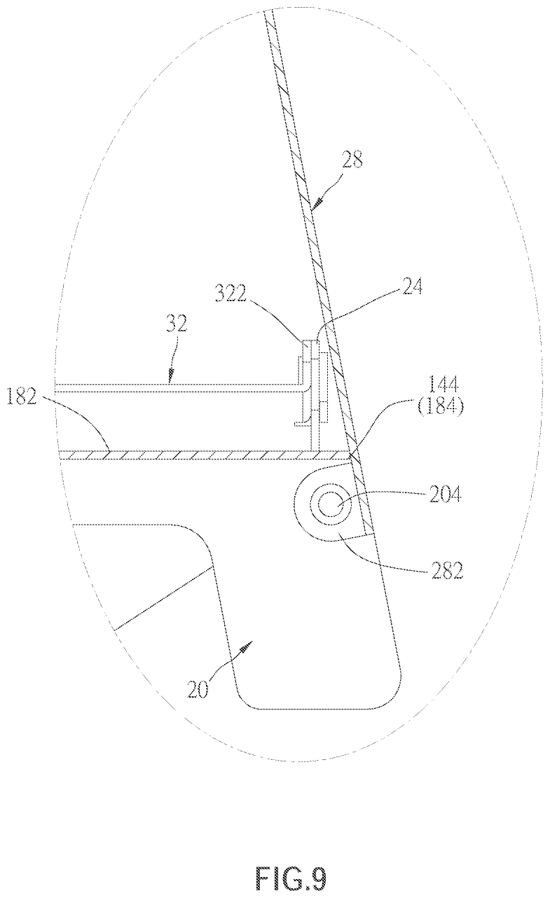

An oven 1 according to a first embodiment of the disclosure is illustrated in FIG. 1 to FIG. 17 and includes a casing 10 and a heat source 36, wherein the casing 10 is adapted to receive a baking object therein. The heat source 36 is adapted to heat an inside of the casing 10. The heat source 36 could be, for example, charcoals or a heater such as a gas burner or an electric heater. The casing 10 includes a base 12, two first plates 28, and two second plates 32.

The base 12 has four side portions including two first side portions 14 and two second side portions 16. In the current embodiment, the two first side portions 14 are respectively located on two opposite sides of the base 12, and the two second side portions 16 are respectively located on another two opposite sides of the base 12 and between the two first side portions 14, but not limited thereto. In practice, one of the first side portions 14 and one of the second side portions 16 are respectively located on the two opposite sides of the base 12, and the other first side portion 14 and the other second side portion 16 are respectively located on the another two opposite sides of the base 12. Each of the first side portions 14 has a blocking portion 144 and two first pivot portions 142 located below the blocking portion 144. Each of the second side portions 16 has two second pivot portions 162.

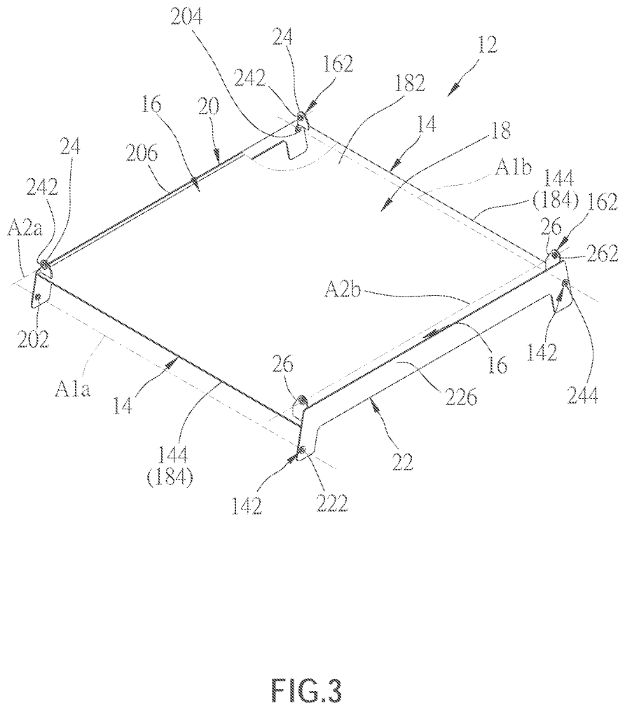

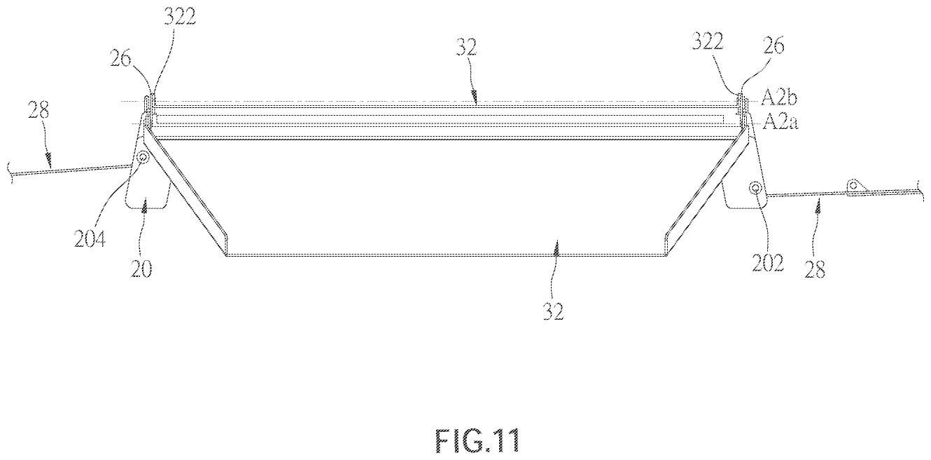

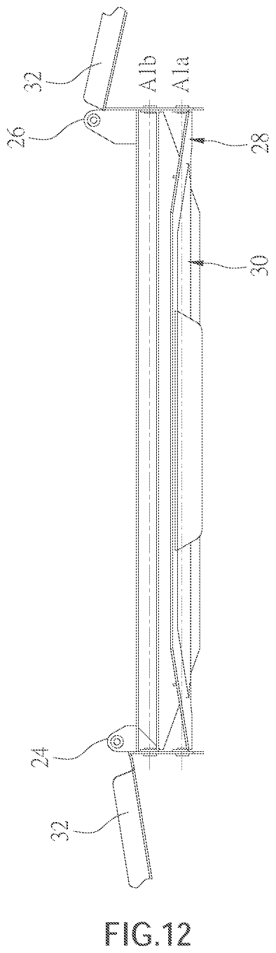

As shown in FIG. 3, FIG. 11, and FIG. 12, the base 12 includes a substrate 18, a first support plate 20, a second support plate 22, two first pivot supports 24, and two second pivot supports 26. The substrate 18 is a rectangular plate and has four side edges 184, wherein two of the opposite side edges 184 of the substrate 18 respectively constitute the blocking portion 144 of one of the two first side portions 14, and the other two opposite side edges 184 of the substrate 18 are respectively engaged with the first support plate 20 and the second support plate 22. An end of the first support plate 20 has a first pivot hole 202, and another end of the first support plate 20 has a second pivot hole 204. An end of the second support plate 22 has a first pivot hole 222, and another end of the second support plate 22 has a second pivot hole 224. The first pivot hole 202 of the first support plate 20 and the first pivot hole 222 of the second support plate 22 face each other. The second pivot hole 204 of the first support plate 20 and the second pivot hole 224 of the second support plate 22 face each other. A position of the first pivot hole 202 of the first support plate 20 and a position of the first pivot hole 222 of the second support plate 22 are higher than a position of the second pivot hole 204 of the first support plate 20 and a position of the second pivot hole 224 of the second support plate 22 in a height direction of the base 12. The end of the first support plate 20 and the end of the second support plate 22 constitute one of the first pivot portions 142, and the another end of the first support plate 20 and the another end of the second support plate 22 constitute the other first pivot portion 142, so that the first support plate 20 and the second support plate 22 jointly have the two first pivot portions 142 located below the substrate 18. Two first axes Ala, Alb are defined, wherein one of the first axes Ala passes through the two first pivot holes 202,222, and the other first axis Alb passes through the two second pivot holes 204,224. In other words, each of the two first axes Ala, Alb passes through the two first pivot portions 142 of one of the two first side portions 14, and the two first axes Ala, Alb are spaced apart from each other.

The two first pivot supports 24 and the two second pivot supports 26 are respectively disposed on four corners of a top surface 182 of the substrate 18, wherein the two first pivot supports 24 are close to the first support plate 20, and the two second pivot supports 26 are close to the second support plate 22. The two first pivot supports 24 are engaged with the top surface 182 of the substrate 18 to constitute one of the second pivot portions 162. Each of the first pivot supports 24 has a first pivot hole 242, wherein the two first pivot hole 242 of the first pivot supports 24 face each other. The two second pivot supports 26 are engaged with the top surface 182 of the substrate 18 and are located on a side of the top surface 182 of the substrate 18 opposite to the two first pivot supports 24. The two second pivot supports 26 constitute the other second pivot portion 162. Each of the second pivot supports 26 has a second pivot hole 262, wherein the two second pivot holes 262 of the first pivot supports 24 face each other. Positions of the two second pivot holes 262 of the second pivot supports 26 are higher than position of the two first pivot holes 242 of the first pivot supports 24 in the height direction of the base 12. In this way, the two first pivot supports 24 and the two second pivot supports 26 respectively form one of the two second pivot portions 162 located on a top of the substrate 18. Two second axes A2a, A2b are defined, wherein one of the second axes A2a passes through the two first pivot holes 242 of the first pivot supports 24, and the other second axis A2b passes through the two second pivot holes 262 of the second pivot supports 26. In other words, each of the second axes A2a, A2b passes through the two second pivot portions 162 of one of the second side portions 16. The two second axes A2a, A2b are spaced apart from each other and the two first axes Ala, Alb.

In the current embodiment, a height of each of the second pivot supports 26 in the height direction of the base 12 is greater than a height of each of the first pivot supports 24 in the height direction of the base 12. The first support plate 20 has an extending section 206 extending upward to be higher than the top surface 182 of the substrate 18 in the height direction of the substrate 18 and be located between the two first pivot supports 24, so that the extending section 206 of the first support plate 20 covers a gap between the two first pivot supports 24. The second support plate 22 has an extending section 226 extending upward to be higher than the top surface 182 of the substrate 18 in the height direction of the substrate 18 and be located between the two second pivot supports 26, so that the extending section 226 of the second support plate 22 covers a gap between the two second pivot supports 26. A height of the extending section 226 of the second support plate 22 in the height direction of the base 12 is greater than a height of the extending section 206 of the first support plate 20 in the height direction of the base 12.

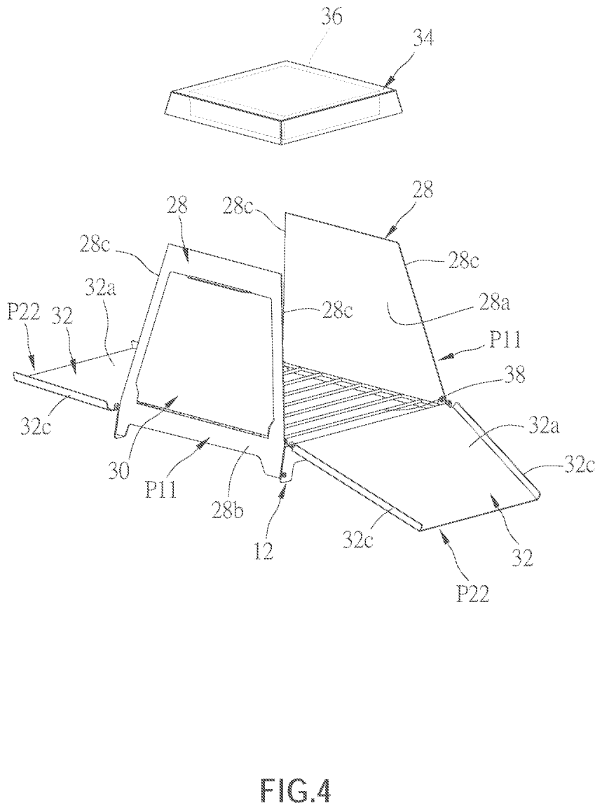

As shown in FIG. 4 to FIG. 9, each of the first plates 28 has two first pivot ears 282 respectively and pivotally connected to one of the two first pivot portions 142 of one of the first side portions 14, so that each of the first plates 28 is pivotable relative to the base 12. More specifically, each of the two first pivot ears 282 of one of the first plates 28 is pivotally connected to either the first pivot hole 202 of the first support plate 20 or the first pivot hole 222 of the second support plate 22, and each of the first pivot ears 282 of the other first plate 28 is pivotally connected to either the second pivot hole 204 of the first support plate 20 or the second pivot hole 224 of the second support plate 22.

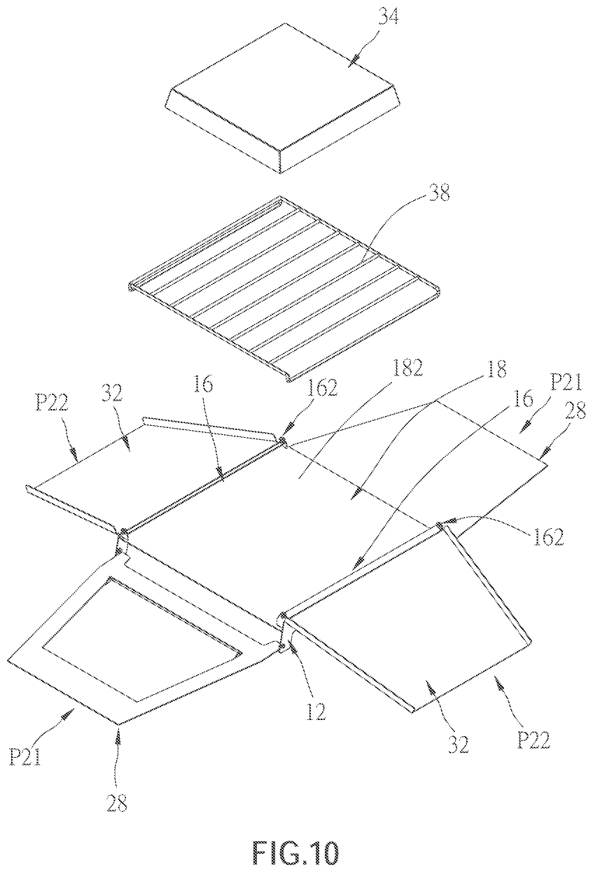

Each of the first plates 28 has a first inner surface 28a, a first outer surface 28b, and two side edges 28c. In the current embodiment, each of the first plates 28 is a trapezoidal plate, wherein each of the side edges 28c is an oblique side edge of the trapezoid, and a distance between the two side edges 28c decreases upward along the height direction of the base 12. When each of the first plates 28 pivots to a first assembled position P11, each of the first plates 28 obliquely abuts against one of the blocking portions 144 for positioning, i.e., the inner surface 28a of each of the first plates 28 abuts against one of the side edges 184 of the substrate 18, so that each of the first plates 28 could be firmly positioned due to a weight of each of the first plates 28 without being held by a user. When both the two first plates 28 are located at the first assembled position P11, the two first inner surfaces 28a of the first plates 28 face each other, and a distance between the two first inner surface 28a gradually decrease upward along the height direction of the base 12. When each of the first plate 28 pivots in a direction away from the substrate 18, each of the first plates 28 could pivot to a first expanded position P21 as shown in FIG. 10.

In an embodiment, each of the first plates 28 could be positioned in a way other than obliquely abutting against one of the blocking portions 144, for example magnetic attraction or being stuck.

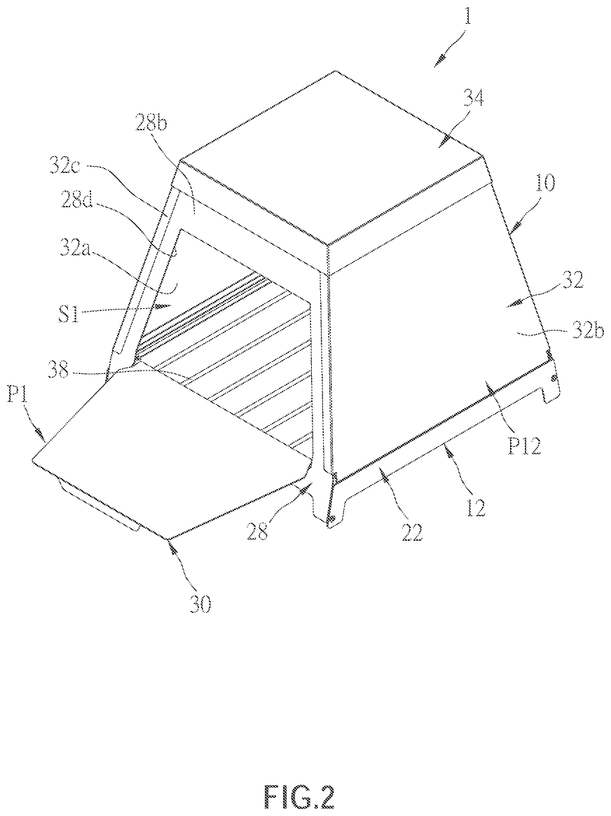

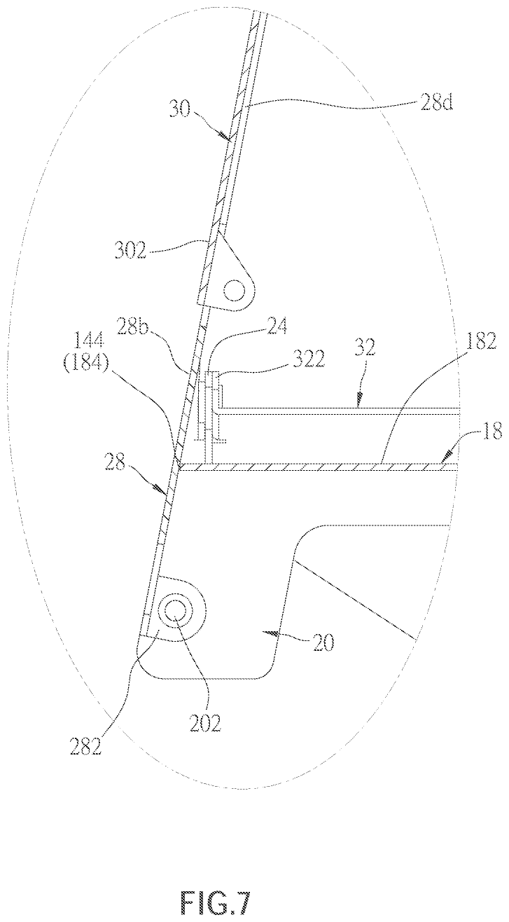

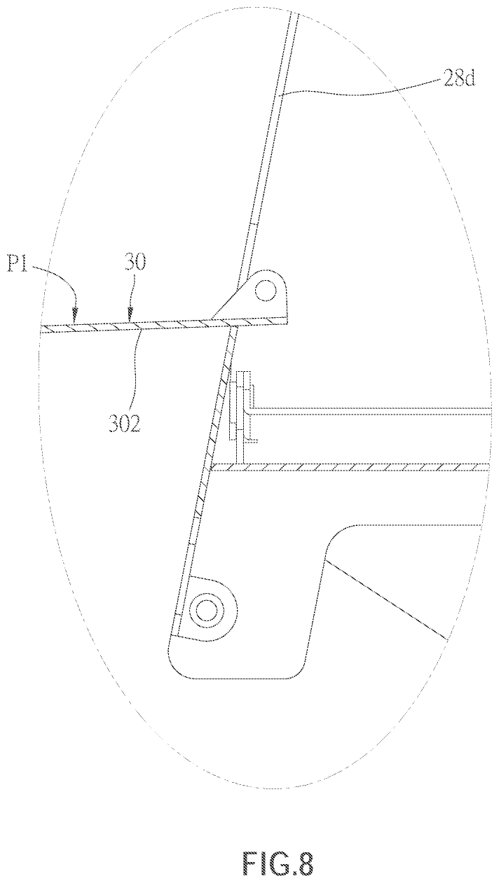

Referring to FIG. 1 and FIG. 2, one of the first plates 28 located on a front side of the oven 1 has entrance 28d, a door 30 which is pivotable is disposed on the first plate 28. When the first plate 28 pivots to the first assembled position P11, the door 30 is pivotable between a closed position P0 and an open position P1. As shown in FIG. 1 and FIG. 7, when the door 30 is located at the closed position P0, the door 30 obliquely abuts against the first plate 28 and closes the entrance 28d. The entrance 28d could be firmly closed due to a weight of the door 30. As shown in FIG. 2 and FIG. 8, when the door 30 is located at the open position P1, the entrance 28d is opened, and an outer surface 302 of the door 30 abuts against a bottom edge of the entrance 28d for positioning. At that time, the door 30 is supported by the first plate 28 to be located at a position higher than the base 12 in the height direction of the base 12. In this way, when the casing 10 is disposed on a loading surface having a small area, the door 30 could be suspended without being supported by the loading surface.

Each of the second plates 32 has two second pivot ears 322 respectively and pivotally connected to one of the two second pivot portions 162 of one of the two second side portions 16, so that each of the second plates 32 is pivotable relative to the base 12. More specifically, each of the two second pivot ears 322 of one of the second plates 32 is pivotally connected to one of the two first pivot holes 242 of the first pivot support 24, and each of the two second pivot ears 322 of the other second plate 32 is pivotally connected to one of the two second pivot holes 262 of the second pivot support 26.

Each of the second plates 32 has a second inner surface 32a, a second outer surface 32b, and two folded edges 32c. In the current embodiment, each of the second plates 32 is a trapezoidal plate, wherein each of the two folded edges 32c is located on one of two sides of each of the second plates 32, and a distance between the two folded edges 32c of each of the second plates 32 decreases upward along the height direction of the base 12. As shown in FIG. 1 and FIG. 2, when each of the first plates 28 pivots to the first assembled position P11 and each of the second plates 32 pivots to a second assembled position P12, the two second plates 32 and the two first plates 28 jointly surround to form a baking space S1. More specifically, the two second inner surfaces 32a of the second plates 32 face each other, wherein the second inner surface 32a of each of the second plates 32 obliquely abuts against one of the side edges 28c of each of the two first plates 28, and a distance between the two second inner surfaces 32a decreases upward along the height direction of the base 12, so that the two second plate 32 could be positioned without being held by the user. Moreover, each of the two folded edges 32c located on the two sides of the second plate 32 abuts against the first outer surface 28b of each of the two first plates 28, so that a gap between the adjacent first plate 28 and the adjacent second plate 32 could be closed. When each of the second plates 32 pivots in the direction away from the substrate 18, each of the second plates 32 could pivot to a second expanded position P22 as shown in FIG. 10.

In the current embodiment, the casing 10 further includes a top cover 34. When each of the first plates 28 pivots to the first assembled position P11 and each of the second plates 32 pivots to the second assembled position P12, the top cover 34 detachably fits around a top of each of the two first plates 28 and a top of each of the two second plates 32, so that a top of the baking space S1 could be closed by the top cover 34, and each of the second plates 32 could be restricted to the second assembled position P12 by the top cover 34. In the current embodiment, the heat source 36 (heater) of the oven 1 is disposed in the top cover 34, but not limited thereto. In other embodiments, the heat source 36, for example a heater or charcoals, could be placed on the substrate 18.

Preferably, the base 12, the two first plates 28, the two second plates 32, the door 30, and the top cover 34 are respectively made of a metal plate.

In the current embodiment, the oven 1 further includes an oven rack 38, wherein the oven rack 38 could be disposed on the substrate 18. The baking object could be placed on the oven rack 38, or directly on the substrate 18 after oven rack 38 is removed from the substrate 18.

Referring to FIG. 10, when the casing 10 is in an expanded state, the baking object having a size larger than a size of the entrance 28d could be placed on the substrate 18 or the oven rack 38, and then each of the two first plates 28 is moved to the first assembled position P11 and each of the two second plates 32 is moved to the second assembled position P12, so that the baking object having the large size could be placed in the baking space S1.

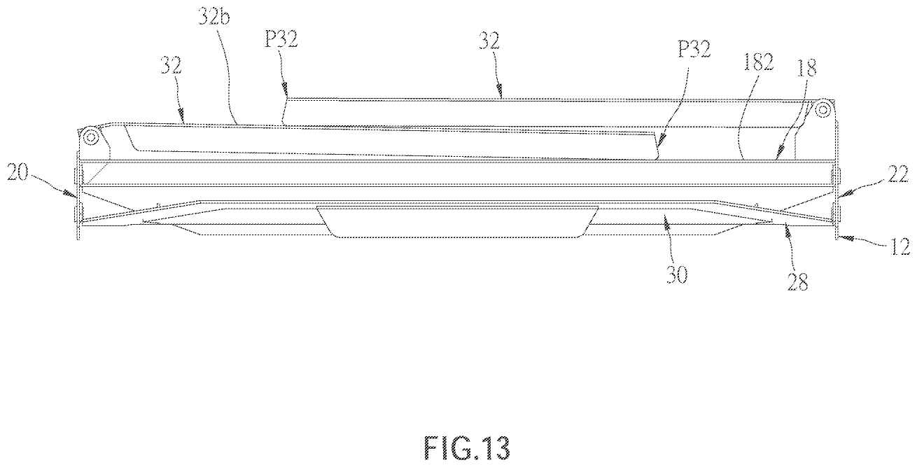

The process of folding the casing 10 is illustrated in FIG. 13 to FIG. 17, wherein each of the first plates 28 is pivotable relative to the base 12 to pivot to a first folded position P31, and each of the second plates 32 is pivotable relative to the base 12 to pivot to a second folded position P32.

Referring to FIG. 13, firstly each of the second plate 32 could pivot to the second folded position P32. As the two second axes A2a, A2b are spaced apart from each other in the height direction of the base 12, the two second plate 32 could be stacked on the substrate 18, i.e., one of the second plates 32 abuts against the top surface 182 of the substrate 18, and the other second plate 32 abuts against the second outer surface 32b of the second plate 32.

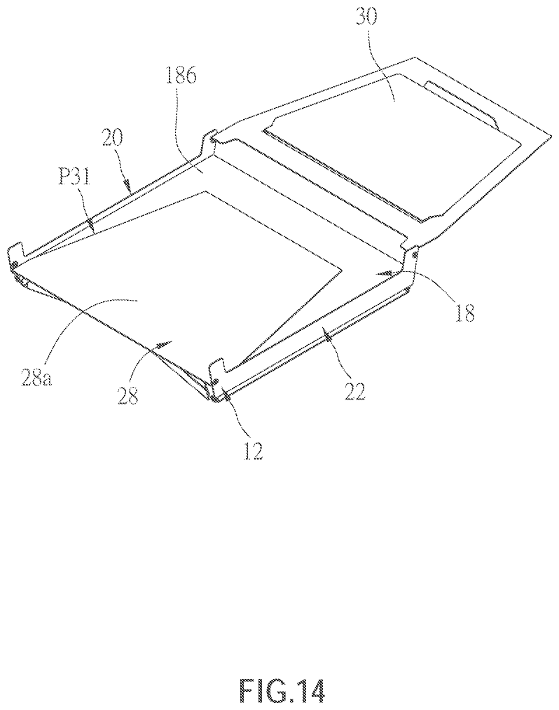

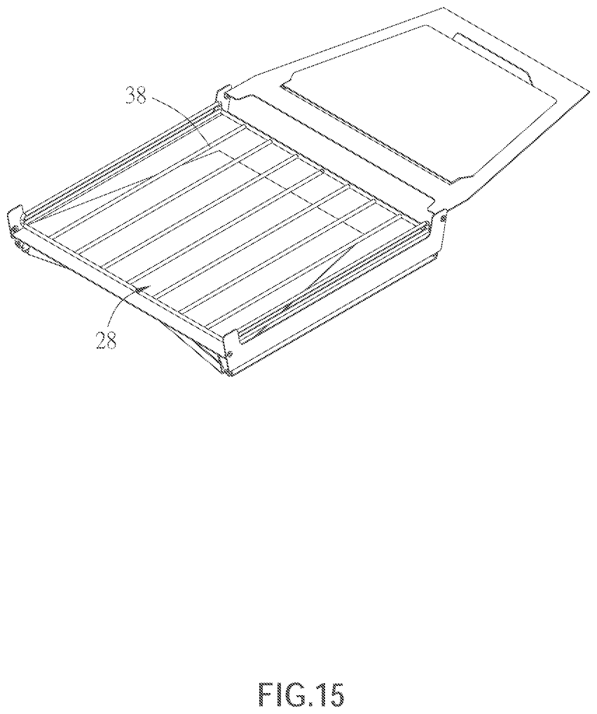

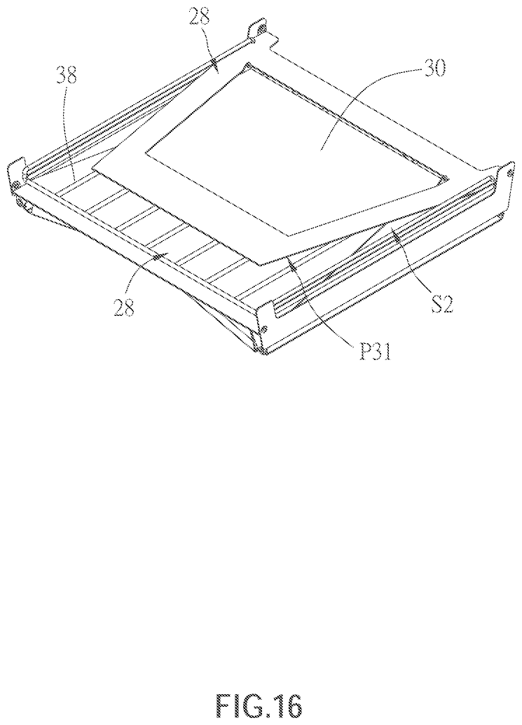

Referring to FIG. 14, after the base 12 is turned upside down, one of the first plates 28 pivots to the first folded position P31. At that time, the first plate 28 abuts against a bottom surface 186 of the substrate 18, and the first inner surface 28a of the first plate 28 is opposite to the bottom surface 186 of the substrate 18. Referring to FIG. 15, the oven rack 38 is placed on the first plate 28. Then, referring to FIG. 16, the first plate 28 having the door 30 pivots to the first folded position P31. As the two first axes Ala, Alb are spaced apart from each other in the height direction of the base 12, the two first plates 28 could be stacked on the substrate 18. In the current embodiment, a receiving space S2 is formed between the two first plates 28 and is adapted to receive the oven rack 38, but not limited thereto. In practice, the receiving space S2 could be formed between the substrate 18 and one of the two first plates 28 closer to the substrate 18 and be adapted to receive the oven rack 38; additionally, the oven rack 38 could be placed between another receiving space formed between the substrate 18 and one of the two second plates 32 closer to the substrate 18.

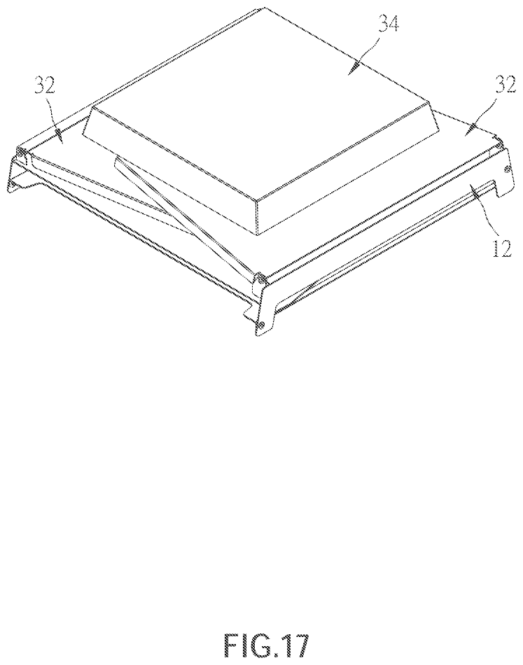

Referring to FIG. 17, after the base 12 is turned upside down, each of the first plates 28 is located below the substrate 18 and each of the second plates 32 is located above the substrate 18, so that a size of the casing 10 could be effectively reduced, thereby conducive to storing or bringing. The top cover 34 could be placed on the two second plates 32 for being stored or brought together.

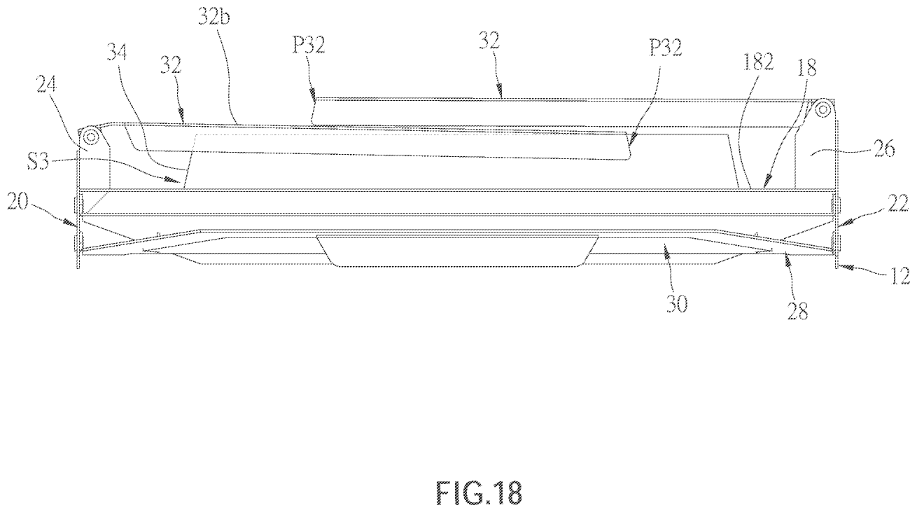

A casing 10 according to an alternative embodiment of the disclosure is illustrated in FIG. 18 and has almost the same structure as that of the first embodiment, except that the height of the each of the two first pivot supports 24 of the alternative embodiment in the height direction of the base 12 is higher than that of the first embodiment, and the height of each of the second pivot supports 26 of the alternative embodiment in the height direction of the base 12 is higher than that of the first embodiment. Thus, when each of the second plates 32 pivots to the second folded position P32, a receiving space S3 is formed between the substrate 18 and one of the second plates 32 closer to the substrate 18 and is adapted to receive the top cover 34, so that a position of the top cover 34 could be restricted, thereby more conducive to storing and bringing the casing 10. In practice, the height of each of the second pivot supports 26 in the height direction of the base 12 could be further increased, so that the receiving space S3 could be formed between the two second plates 32 and be adapted to receive the top cover 34.

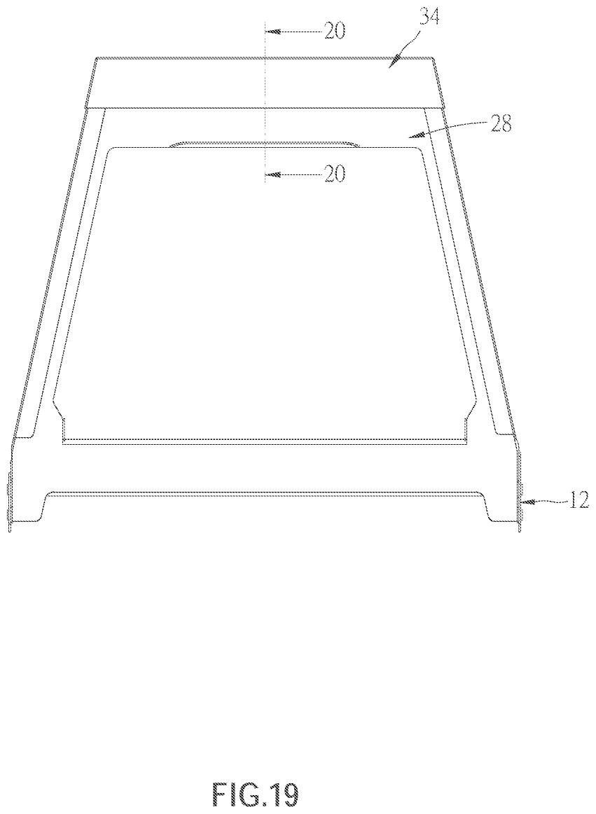

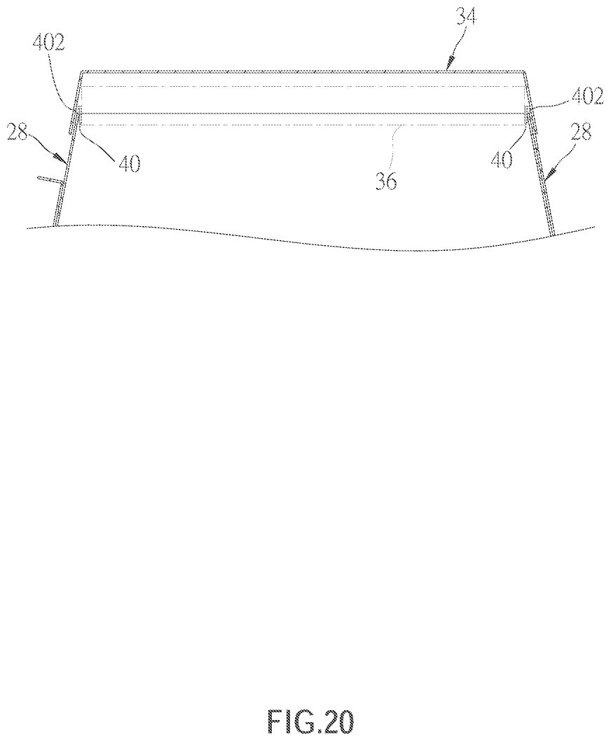

An oven 2 according to a second embodiment of the disclosure is illustrated in FIG. 19 and FIG. 20 and further includes two supporting structures 40 disposed on an inside of the top cover 34 based on the first embodiment, wherein each of the two supporting structures 40 is located one of two opposite sides of the inside of the top cover 34. When the top cover 34 fits around the top of each of the two first plates 28, the top of each of the two first plates 28 is inserted into a positioning groove 402 of one of the two supporting structures 40, so that each of the supporting structures 40 abuts the top of one of the two first plates 28. In this way, the top of each of the first plates 28 is supported by one of the supporting structures 40, and a bottom of each of the first plate 28 is supported by one of the blocking portions 144 of the base 12, so that a strength of each of the first plates 28 could be increased.

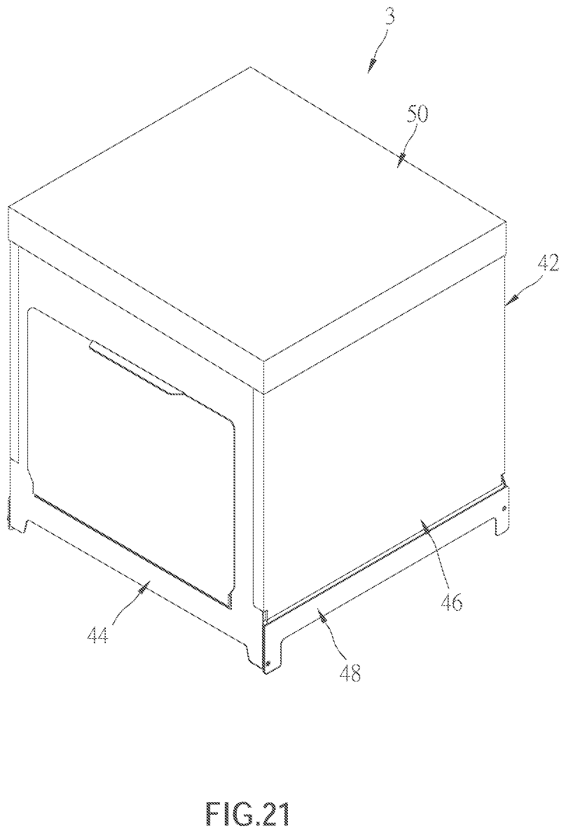

An oven 3 according to a third embodiment of the disclosure is illustrated in FIG. 21 and has almost the same structure as that of the first embodiment, except that each of the first plates 44 and each of the second plates 46 of the casing 42 is a rectangular plate. A folded state of the casing 42 is the same as that of the first embodiment, i.e., the two first plates 44 are stacked on the bottom of the base 48, and the two second plates 46 are stacked on the top of the base 48, and therefore the folded state of the casing 42 is not repeated here. Additionally, each of the first plates 44 stands straight to abut against one of the blocking portions 144 of the base 48 for positioning, but not limited thereto. For example, each of the first plates 44 could be positioned through magnetic attraction or being stuck. The two supporting structures 40 of the second embodiment could be disposed in the inside of the top cover 50 of the casing 42 of the third embodiment to respectively support the top of one of the two first plates 44

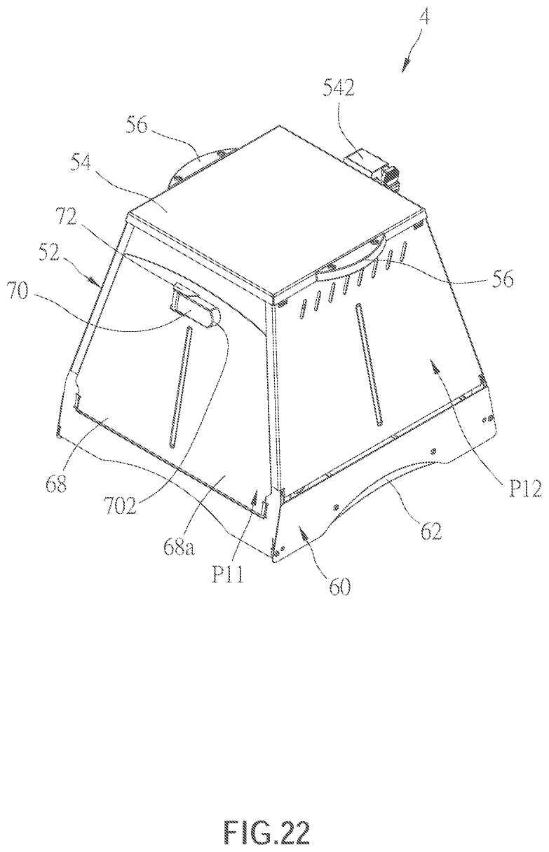

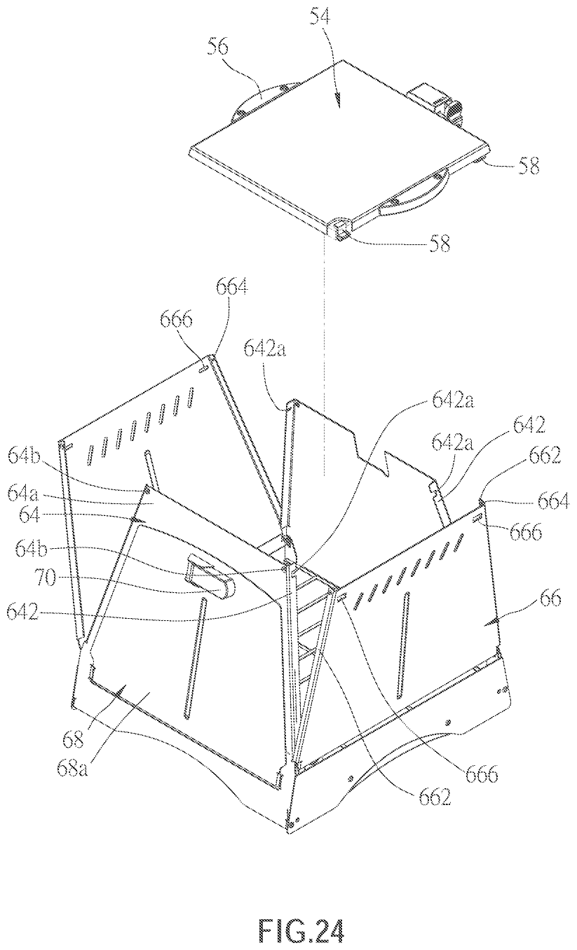

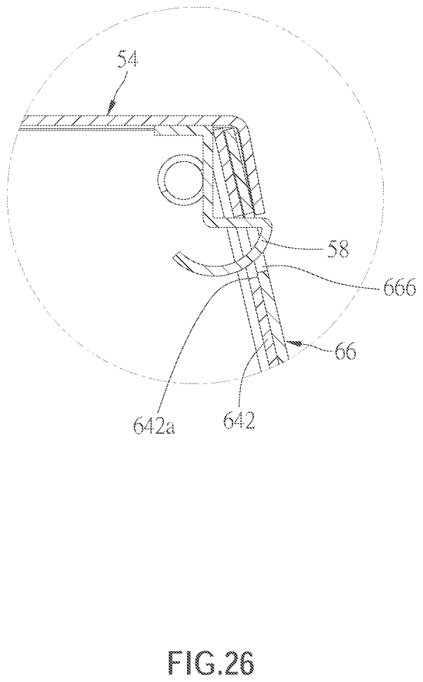

An oven 4 according to a fourth embodiment of the disclosure is illustrated in FIG. 22 to FIG. 29 and has almost the same structure as that of the first embodiment, except that:

A gas connector 542 is disposed on a rear side of the top cover 54 of the casing 52 and is connected between the heater and a gas source. Two anti-scald handles 56 are respectively connected to two sides of the top cover 54. The two anti-scald handles 56 could be made of thermal insulation materials, for example wood or Bakelite. The top cover 54 could be held through the two anti-scald handles 56.

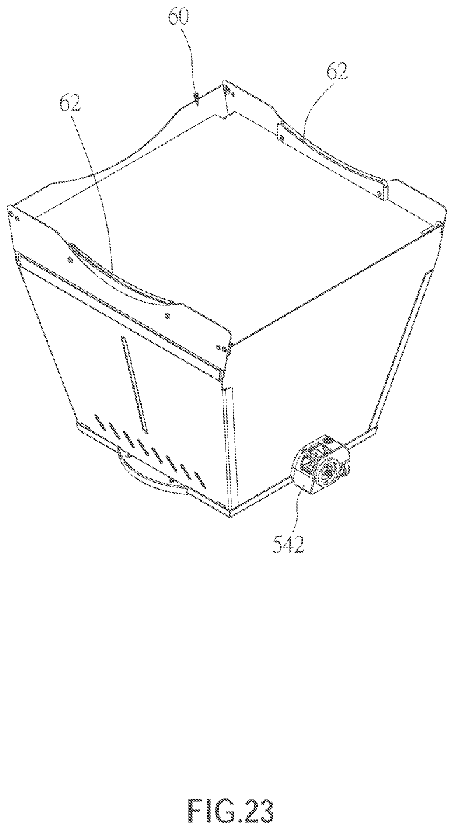

Additionally, referring to FIG. 23, two grip pads 62 are respectively disposed on two sides of the base 60, wherein a thickness of each of the two grip pads 62 is greater than a thickness of plates located on the two sides of the base 60, so that a user could move the casing 52 more comfortably.

An inside of the top cover 54 has at least two locking members 58 that are elastic. At least two of the top of the two first plates 64 and the top of the two second plates 66 have at least one locking hole 642a, 666. In the current embodiment, the at least two locking members 58 includes four locking members 58 respectively located at a position close to one of four corners of the top cover 54. Two sides of each of the first plates 64 respectively have a folded edge 642, wherein a top of each of the folded edges 642 has a locking hole 642a forming an open side on an edge of the corresponding folded edge 642. Two sides of each of the second plates 66 respectively have a locking hole 666 located at a position on the corresponding second plate 66 close to one of the folded edges 662. Two sides of a first outer surface 64a of each of the first plates 64 respectively have a recess 64b. An inside of each of the folded edges 662 of each of the second plates 66 has a protrusion 664. Both the recesses 64b and the protrusions 664 are formed by stamping.

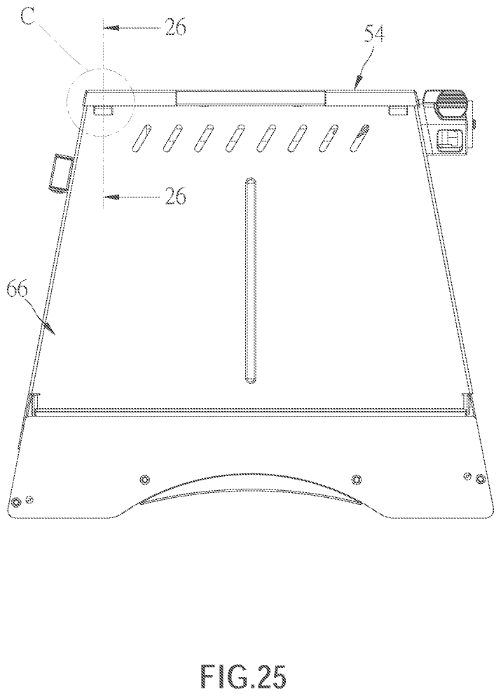

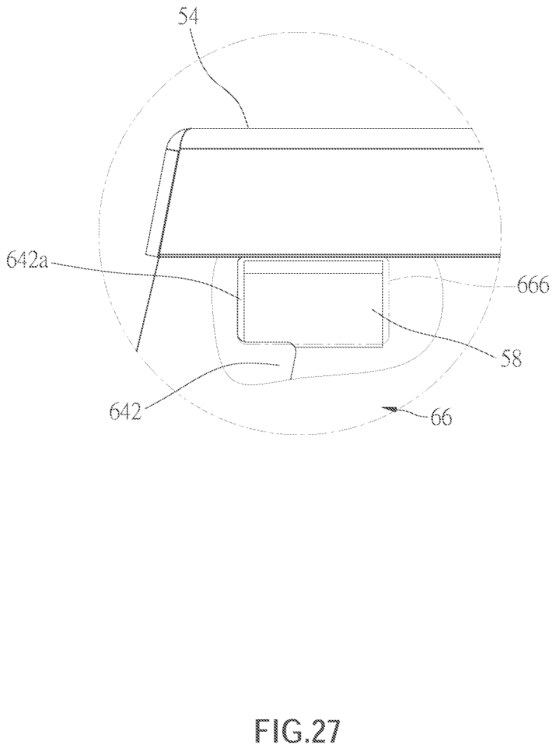

When each of the first plates 64 is located at the first assembled position P11 and each of the second plates 66 is located at the second assembled position P12, each of the protrusions 664 enters one of the recesses 64b for positioning by the protrusions matching with the recesses, so that each of the first plates 64 and each of the second plates 66 could not be easily moved due to an external force. Additionally, referring to FIG. 25 to FIG. 27, the second plate 66 shown in FIG. 27 is partially removed for illustrating the locking hole 642a. Each of the locking holes 642a of the folded edges 642 of each of the first plates 64 corresponds to one of the locking holes 666 of one of the second plates 66. In this way, when the top cover 54 fit around the top of each of the two first plates 64 and the top of each of the two second plates 66, a curved surface of a bottom of each of the locking members 58 is guided by a top edge of one of the second plates 66 and/or a top end edge of one of the first plates 64 to elastically deform, so that each of the locking members 58 could enter one of the locking holes 642a, 666 to be correspondingly stuck at the locking hole 642a, 666, thereby preventing the top cover 54 from being detached. Moreover, each of the locking members 58 could form a supporting structure, wherein each of the locking holes 642a of the folded edges 642 of each of the first plates 64 could abut against a side edge of one of the locking members 58. In this way, when each of the first plates 64 is pressed due to an external force, a hole edge of each of the locking holes 642a could abut against the side edge of one of the locking members 58, thereby increasing a strength of each of the first plates 64.

When the top cover 54 is required to be removed, each of the locking member 58 is pressed and the top cover 54 is lifted, so that the top cover 54 could be removed.

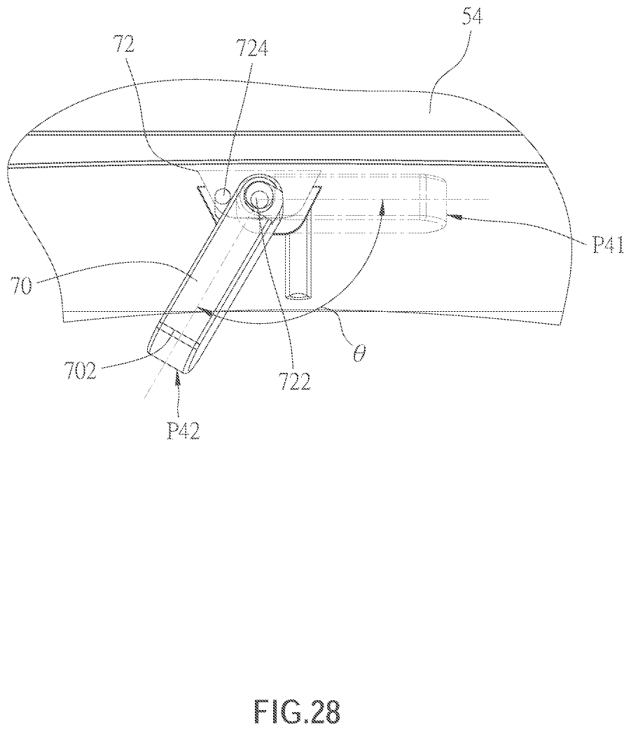

The door 68 has a handle 70. In the current embodiment, the handle 70 is disposed on an outer surface 68a of the door 68 through a pivot support 72, wherein the handle 70 could be made of thermal insulation materials, for example wood or Bakelite. As shown in FIG. 28, the pivot support 72 has a pivot 722 and a blocking rod 724. The handle 70 is pivotally connected to the pivot 722. The blocking rod 724 is located on a side of the pivot 722. The handle 70 is pivotable between a first position P41 and a second position P42. When the handle 70 is located at the first position P41, a free end 702 of the handle 70 is close to the door 68. When the handle 70 is located at the second position P42, the free end 702 of the handle 70 is away from the outer surface 68a of the door 68, and another end of the handle 70 opposite to the free end 702 abuts against blocking rod 724, so that a pivot degree θ of the handle 70 could be restricted. The pivot degree θ of the handle 70 between the first position P41 and the second position P42 is greater than 90°, preferably ranging between 110° and 130°. In the current embodiment, the pivot degree θ substantially is 120°.

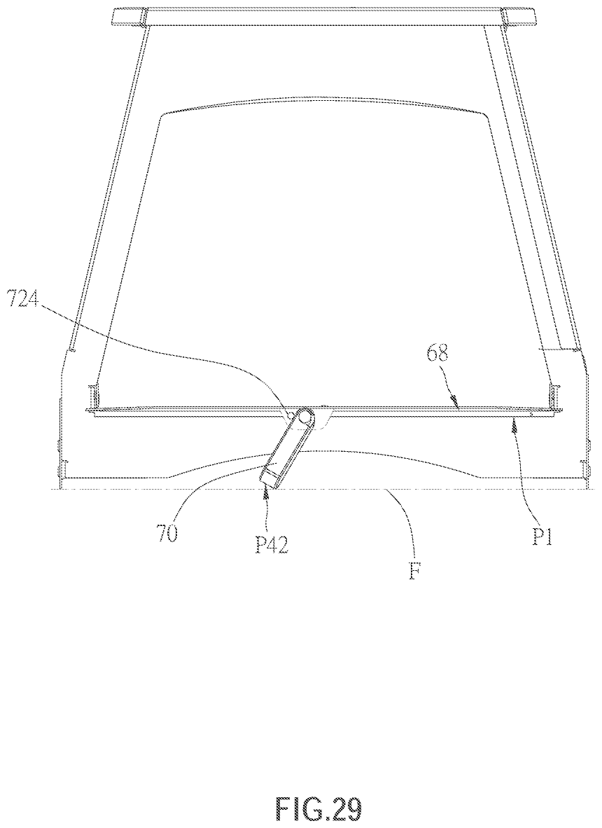

The handle 70 could be pulled to pivot the door 68. Referring to FIG. 29, when the door 68 is located at the open position P1 and the handle 70 is located at the second position P42, the free end 702 of the handle 70 abuts against a loading surface F. In this way, the handle 70 forms a support of the door 68, so that the loading capacity of the door 68 is increased, thereby allowing a user to temporarily place objects, such as food, cooking utensils, or oven rack, on the opened door 68.

It must be pointed out that the embodiments described above are only exemplary embodiments of the present invention. All equivalent structures which employ the concepts disclosed in this specification and the appended claims should fall within the scope of the present invention.

What is claimed is:

1. A casing of an oven, comprising:
a base having two first side portions and two second side portions, wherein each of the two first side portions has two first pivot portions; each of the two second side portions has two second pivot portions: two first axes and two second axes are defined, wherein each of the two first axes passes through the two first pivot portions of one of the two first side portions; each of the two second axes passes through the two second pivot portions of one of the two second side portions: each of the two first axes and the two second axes are spaced apart from one another in a height direction of the base;
two first plates respectively having two first pivot ears, wherein each of the two first pivot ears of each of the two first plates is pivotally connected to one of the two first pivot portions of one of the two first side portions: each of the two first plates is pivotable between a first folded position and a first assembled position relative to the base: when each of the two first plates pivots to the first folded position, the two first plates are stacked in the height direction of the base; and
two second plates respectively having two second pivot ears, wherein each of the two second pivot ears of each of the two second plates is pivotally connected to one of the two second pivot portions of one of the two second side portions: each of the two second plates is pivotable between a second folded position and a second assembled position relative to the base; when each of the two second plates pivots to the second folded position, the two second plates are stacked in the height direction of the base;
wherein when each of the two first plates pivots to the first assembled position and each of the two second plates pivots to the second assembled position, the two first plates and the two second plates jointly surround to form a baking space.

2. The casing of the oven as claimed in claim 1, wherein the base comprises a substrate; the two first pivot portions are located below the substrate, and the two second pivot portions are located above the substrate; when each of the two first plates pivots to the first folded position, each of the two first plates is located below the substrate: when each of the two second plates pivots to the second folded position, each of the two second plates is located above the substrate.

3. The casing of the oven as claimed in claim 2, wherein the two first side portions are respectively located on two opposite sides of the base; each of the two first plates has a first inner surface and two side edges: each of the two second plates has a second inner surface; each of the two first side portions of the base has a blocking portion; when each of the two first plates pivots to the first assembled position, each of the two first plates abuts against the blocking portion of one of the two first side portions for positioning: when each of the two first plates pivots to the first assembled position and each of the two second plates pivots to the second assembled position, the first inner surface of each of the two first plates faces the first inner surface of the other first plate, and the second inner surface of each of the two second plates faces the second inner surface of the other second plate and abuts against one of the two side edges of each of the two first plates.

4. The casing of the oven as claimed in claim 3, wherein the base comprises two first pivot supports, two second pivot supports, a first support plate, and a second support plate; the two first pivot supports are engaged with a top surface of the substrate and constitute one of the two second pivot portions: the two second pivot supports are engaged with the top surface of the substrate, are located on a side of the top surface of the substrate opposite to the two first pivot supports, and constitute the other second pivot portion: the first support plate and the second support plate are respectively engaged with two opposite side edges of the substrate; an end of the first support plate and an end of the second support plate constitute one of the two first pivot portions, and another end of the first support plate and another end of the second support plate constitute the other first pivot portion.

5. The casing of the oven as claimed in claim 4, wherein the second support plate is close to the two second pivot supports and has an extending section located between the two second pivot supports.

6. The casing of the oven as claimed in claim 3, wherein when each of the two first plates pivots to the first assembled position, each of the two first plates obliquely abuts against the blocking portion of one of the two first side portions for positioning.

7. The casing of the oven as claimed in claim 6, wherein one of the two first plates has an entrance and a door which is pivotable: when the first plate pivots to the first assembled position, the door is pivotable between a closed position and an open position: when the door is located at the closed position, the door obliquely abuts against the first plate and closes the entrance: when the door is located at the open position, the entrance is opened.

8. The casing of the oven as claimed in claim 7, wherein when the door is located at the open position, an outer surface of the door abuts against a bottom edge of the entrance for positioning.

9. The casing of the oven as claimed in claim 7, wherein a handle is disposed on the door and is pivotable between a first position and a second position: when the handle is located at the first position, a free end of the handle is close to the door; when the handle is located at the second position, the free end of the handle is away from the door; when the door is located at the open position and the handle is located at the second position, the free end is adapted to abut against a loading surface.

10. The casing of the oven as claimed in claim 9, wherein a pivot degree of the handle between the first position and the second position is greater than 90°.

11. The casing of the oven as claimed in claim 3, wherein the substrate has two side edges respectively constituting the blocking portion of one of the two first side portions.

12. The casing of the oven as claimed in claim 3, wherein each of the two first plates has a first outer surface, two sides of each of the two second plates respectively have a folded edge: when each of the two first plates pivots to the first assembled position and each of the two second plates pivots to the second assembled position, each of the two folded edges of each of the two second plates abuts against the first outer surface of each of the two first plates.

13. The casing of the oven as claimed in claim 12, wherein an inside of each of the two folded edges of each of the two second plates has a protrusion: two sides of the first outer surface of each of the two first plates respectively has a recess; when each of the two first plates pivots to the first assembled position and each of the two second plates pivots to the second assembled position, each of the protrusions matches with one of the recesses for positioning.

14. The casing of the oven as claimed in claim 2, wherein when each of the two first plates pivots to the first folded position, a receiving space is formed between the two first plates.

15. The casing of the oven as claimed in claim 2, wherein when each of the two first plates pivots to the first folded position, a receiving space is formed between the substrate and one of the two first plates.

16. The casing of the oven as claimed in claim 2, further comprising a top cover, wherein when each of the two first plates pivots to the first assembled position and each of the two second plates pivots to the second assembled position, the top cover detachably fits around a top of each of the two first plates and a top of each of the two second plates; when each of the two second plates pivots to the second folded position, a receiving space is formed between the substrate and one of the two second plates and is adapted to receive the top cover.

17. The casing of the oven as claimed in claim 2, further comprising a top cover, wherein when each of the two first plates pivots to the first assembled position and each of the two second plates pivots to the second assembled position, the top cover detachably fits around a top of each of the two first plates and a top of each of the two second plates: when each of the two second plates pivots to the second folded position, a receiving space is formed between the two second plates and is adapted to receive the top cover.

18. The casing of the oven as claimed in claim 1, further comprising a top cover, wherein when each of the two first plates pivots to the first assembled position and each of the two second plates pivots to the second assembled position, the top cover detachably fits around a top of each of the two first plates and a top of each of the two second plates.

19. The casing of the oven as claimed in claim 18, wherein an inside of the top cover has two supporting structures; when the top cover fits around the top of each of the two first plates, each of the two supporting structures blocks one of the two first plates.

20. The casing of the oven as claimed in claim 18, wherein an inside of the top cover has at least two locking members; at least two of the top of the two first plates and the top of the two second plates have at least one locking hole; when the top cover fits around the top of each of the two first plates and the top of each of the two second plates, each of the at least two locking members enters either the at least one locking hole of one of the two first plates or the at least one locking hole of one of the two second plates.
